(19) United States
(12) Patent Application Publication
(10) Pub. No.: US 2014/0094531 A1
(43) Pub. Date: Apr. 3, 2014

(54) RIGID POLYURETHANE AND POLYISOCYANURATE FOAMS BASED ON FATTY ACID MODIFIED POLYETHERPOLYOLS

(71) Applicant: BASF SE, Ludwigshafen (DE)

(72) Inventors: Gunnar KAMPF, Stemwede-Haldem (DE); Olaf JACOBMEIER, Luebbecke (DE); Tobias KALUSCHKE, Dinklage (DE); Christian KOENIG, Mannheim (DE)

(73) Assignee: BASF SE, Ludwigshafen (DE)

(21) Appl. No.: 14/034,745

(22) Filed: Sep. 24, 2013

Related U.S. Application Data
(60) Provisional application No. 61/706,154, filed on Sep. 27, 2012.

(51) Int. Cl. C08G 18/32; C08J 9/00

(52) U.S. Cl. CPC C08G 18/3206; C08J 9/0038
USPC 521/107; 521/157; 252/183.11

(57) ABSTRACT

A process for producing rigid polyurethane foams or rigid polyisocyanurate foams is provided. The process contains the reaction of polyisocyanate, fatty acid modified polyetherpolyol, polyetherpolyol, optionally flame retardant, blowing agent, catalyst, and optionally further auxiliary and/or admixture agent, wherein the polyetherpolyol is obtained by a process containing reacting orthotolylenediamine and optionally further co-starters with alkylene oxide containing ethylene oxide wherein the ethylene oxide content is more than 20 wt %, and then reacting the reaction product with alkylene oxide containing propylene oxide wherein the 1,2-propylene oxide content is more than 20 wt %, in the presence of a catalyst.

The present invention relates to a process for producing rigid polyurethane and polyisocyanurate foams by using fatty acid modified polyetherpolyols and also ortho-tolylenediamine based polyetherpolyols. The present invention also relates to the rigid foams thus obtainable and to their use for producing sandwich elements having rigid or flexible outer layers. The present invention further relates to the underlying polyol components.

The production of rigid polyurethane foams is known and is described in numerous patent and literature publications. Rigid polyurethane foams are typically produced by reacting organic polyisocyanates with one or more compounds having two or more reactive hydrogen atoms, especially with polyetherpolyols from alkylene oxide polymerization or polyesterpolyols from the polycondensation of alcohols with dicarboxylic acids, in the presence of blowing agents, catalysts and optionally auxiliaries and/or admixture agents.

Rigid polyurethane foams used to be mostly blown with chlorofluoroalkanes (CFCs), preferably trichlorofluoromethane. These blowing gases, however, are disadvantageous because of their adverse impact on the environment. Hydrocarbons, preferably pentanes, have now come to be mostly used as successors to the CFCs. Thus, EP-A-421 269 describes the use of cyclopentane and/or cyclohexane, optionally mixed with other hydrocarbons, as blowing agents. These blowing agents, however, differ from the halogenated blowing agents in various respects. Thus they are less compatible with the other constituent parts of polyurethane systems. This leads to rapid separation of the components comprising blowing agent.

The use of C-5 alkanes, specifically aliphatic pentane, and their often minimal solubility in the polyol component can lead to problems in the production of composite elements. An insufficient pentane solubility on the part of the polyol component and, more particularly, application of the reaction mixture in very thin layers can lead to an increased tendency for surface defects to appear at the transition between the outer layer and the foam. This may result in reduced outer layer adherence and/or insulation performance as well as impaired appearance of the composite parts.

This defect can admittedly be remedied by adding higher molecular weight polyether alcohols to improve the homogeneity of the polyol component such that processing on the customary machines becomes possible, but only by accepting a deterioration in the curing of the rigid polyurethane foams. Rapid curing of the reaction mixture is necessary and enables processors to maintain the desired high productivity in the form of short demolding times or high belt speeds.

The addition of short-chain crosslinker polyols does generally improve curing, but has a disadvantageous effect on foam brittleness. Excessive brittleness can lead to cracks in the foam especially during cutting or assembly operations and also to poor outer layer adherence.

It is known from the prior art that adding proportions of OH-containing fatty acid esters such as castor oil can contribute to an improved pentane solubility on the part of the polyol component and to lower brittleness on the part of the rigid foam obtained. Printed publications EP 0 728 783 A1, EP 0 826 708 A1 and WO 2010/106067 A1 describe processes for producing rigid PU foams wherein the polyol component comprises castor oil. Castor oil can be advantageous for the surface properties of the foam. On the other hand, castor oil in the presence of water and the attendant phase separation can lead to an instability on the part of the pure polyol component even if it does not contain any pentane. Yet a phase-stable polyol component is a necessary prerequisite for a consistent and reproducible manufacture of rigid polyurethane foams.

The process described in EP 0 826 708 A1 is disadvantageous not only because of the poor adherence on the part of the rigid PU foams formed but also because of the high viscosity on the part of the polyol component. Especially for processing on double-belt equipment, the viscosity of the polyol component should be sufficiently low as to enable pumpability on common manufacturing equipment.

The rigid PU foams produced as described in WO 2010/106067 A1 already possess good adherence and good surface finish, but are still in need of improvement as regards the shelflife of the polyol component especially at comparatively high water levels.

The foams obtainable according to the prior art described above are thus unable to meet all requirements.

The present invention therefore has for its object to provide a polyol component for producing rigid polyurethane and polyisocyanurate foams which has very good solubility for physical blowing agents and a high phase stability. The polyol component should have a low viscosity. It is also an object of the present invention to provide rigid polyurethane and polyisocyanurate foams which cure rapidly and have low brittleness.

We have found that this object is achieved by a process for producing rigid polyurethane foams or rigid polyisocyanurate foams comprising the reaction of

A) at least one polyisocyanate,

B) at least one fatty acid modified polyetherpolyol,

C) at least one polyetherpolyol,

D) optionally one or more polyols other than those of components B) and C),

E) optionally one or more flame retardants,

F) one or more blowing agents,

G) one or more catalysts, and

H) optionally further auxiliaries and/or admixture agents,

wherein component C) is obtained by a process comprising

c1) reacting orthotolylenediamine and optionally further co-starters with at least one alkylene oxide comprising ethylene oxide wherein the ethylene oxide content is more than 20 wt %, based on the weight amount of alkylene oxides, and then

c2) reacting the reaction product from step c1) with at least one alkylene oxide comprising propylene oxide wherein the propylene oxide content is more than 20 wt %, based on the weight amount of alkylene oxides, in the presence of a catalyst,

and also by the polyol component defined by components B) to H).

Component A

A polyisocyanate for the purposes of the present invention is an organic compound comprising two or more than two reactive isocyanate groups per molecule, i.e., the functionality is not less than 2. When the polyisocyanates used or a mixture of two or more polyisocyanates do not have a unitary functionality, the number-weighted average functionality of component A) used will be not less than 2.

Useful polyisocyanates A) include the aliphatic, cycloaliphatic, araliphatic and preferably aromatic polyfunctional isocyanates which are known per se. Polyfunctional isocyanates of this type are known per se or are obtainable by methods known per se. Polyfunctional isocyanates can more particularly also be used as mixtures, in which case component A) comprises various polyfunctional isocyanates. The number of isocyanate groups per molecule in polyfunctional isocyanates useful as polyisocyanate is two (and so the polyfunctional isocyanates in question are referred to hereinbelow as diisocyanates) or more than two.

Particularly the following may be mentioned in detail: alkylene diisocyanates having 4 to 12 carbon atoms in the alkylene radical, such as 1,12-dodecane diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate and also any desired mixtures of these isomers, 1-isocyanato-3,3,5-trimethyl-5-isocyanatomethylcyclohexane (IPDI), 2,4- and 2,6-hexahydrotolylene diisocyanate and also the corresponding isomeric mixtures, 4,4′-, 2,2′- and 2,4′-dicyclohexylmethane diisocyanate and also the corresponding isomeric mixtures, and preferably aromatic polyisocyanates, such as 2,4- and 2,6-tolylene diisocyanate and the corresponding isomeric mixtures, 4,4′-, 2,4′- and 2,2′-diphenylmethane diisocyanate and the corresponding isomeric mixtures, mixtures of 4,4′- and 2,2′-diphenylmethane diisocyanates, polyphenylpolymethylene polyisocyanates, mixtures of 2,4′-, 2,4′- and 2,2′-diphenylmethane diisocyanates and polyphenylpolymethylene polyisocyanates (crude MDI) and mixtures of crude MDI and tolylene diisocyanates.

Of particular suitability are 2,2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethylbiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Frequent use is also made of modified polyisocyanates, i.e. products obtained by chemical conversion of organic polyisocyanates and having two or more than two reactive isocyanate groups per molecule. Polyisocyanates comprising ester, urea, biuret, allophanate, carbodiimide, isocyanurate, uretdione, carbamate and/or urethane groups may be mentioned in particular.

The following embodiments are particularly preferable as polyisocyanates of component A):
i) polyfunctional isocyanates based on tolylene diisocyanate (TDI), especially 2,4-TDI or 2,6-TDI or mixtures of 2,4- and 2,6-TDI;
ii) polyfunctional isocyanates based on diphenylmethane diisocyanate (MDI), especially 2,2′-MDI or 2,4′-MDI or 4,4′-MDI or oligomeric MDI, which is also known as polyphenylpolymethylene isocyanate, or mixtures of two or three of the aforementioned diphenylmethane diisocyanates, or crude MDI, which is obtained in the production of MDI, or mixtures of at least one oligomer of MDI and at least one aforementioned low molecular weight MDI derivative;
iii) mixtures of at least one aromatic isocyanate as per embodiment i) and at least one aromatic isocyanate as per embodiment ii).

Polymeric diphenylmethane diisocyanate is very particularly preferred as polyisocyanate. Polymeric diphenylmethane diisocyanate (called polymeric MDI hereinbelow) is a mixture of binuclear MDI and oligomeric condensation products and thus derivatives of diphenylmethane diisocyanate (MDI). Polyisocyanates may preferably also be constructed from mixtures of monomeric aromatic diisocyanates and polymeric MDI.

Polymeric MDI, in addition to binuclear MDI, comprises one or more polynuclear condensation products of MDI with a functionality of more than 2, especially 3 or 4 or 5. Polymeric MDI is known and often referred to as polyphenylpolymethylene isocyanate or else as oligomeric MDI. Polymeric MDI is typically constructed from a mixture of MDI-based isocyanates of differing functionality. Polymeric MDI is typically used in admixture with monomeric MDI.

The (average) functionality of a polyisocyanate comprising polymeric MDI can vary in the range from about 2.2 to about 5, especially from 2.3 to 4, especially from 2.4 to 3.5. Crude MDI, obtained as an intermediate in the production of MDI, is more particularly such a mixture of MDI-based polyfunctional isocyanates having different functionalities.

Polyfunctional isocyanates or mixtures of two or more polyfunctional isocyanates based on MDI are known and available for example from BASF Polyurethanes GmbH under the name of Lupranat®.

The functionality of component A) is preferably at least two, especially at least 2.2 and more preferably at least 2.4. The functionality of component A) is preferably from 2.2 to 4 and more preferably from 2.4 to 3.

The isocyanate group content of component A) is preferably from 5 to 10 mmol/g, especially from 6 to 9 mmol/g and more preferably from 7 to 8.5 mmol/g. A person skilled in the art is aware of a reciprocal relationship between the isocyanate group content in mmol/g and the so-called equivalence weight in g/equivalent. The isocyanate group content in mmol/g is obtained from the content in wt % according to ASTM D-5155-96 A.

In a particularly preferred embodiment, component A) consists of at least one polyfunctional isocyanate selected from diphenylmethane 4,4′-diisocyanate, diphenylmethane 2,4′-diisocyanate, diphenylmethane 2,2′-diisocyanate and oligomeric diphenylmethane diisocyanate. In this preferred embodiment, component (A) more preferably comprises oligomeric diphenylmethane diisocyanate and has a functionality of at least 2.4.

The viscosity (DIN 53018 at 25° C.) of component A) used can vary within wide limits. The viscosity of component A) is preferably in the range from 100 to 3000 mPa·s and more preferably in the range from 200 to 2500 mPa·s.

Component B

According to the present invention, component B) consists of one or more fatty acid modified polyetherpolyols. A fatty acid modified polyetherpolyol for the purposes of the present invention is a reaction product of at least one starter molecule with alkylene oxide and at least one fatty acid and/or at least one fatty acid derivative. Polyols of this type are known per se to a person skilled in the art.

In one preferred embodiment, component B is the reaction product of
B1) from 15 to 63 wt %, especially from 20 to 55 wt %, of one or more polyols or polyamines having an average functionality of 2.5 to 8,
B2) from 2 to 30 wt %, especially from 5 to 25 wt %, of one or more fatty acids and/or fatty acid monoesters,
B3) from 35 to 83 wt %, especially from 40 to 75 wt %, of one or more alkylene oxides having 2 to 4 carbon atoms,

all based on the weight amount of components B1) to B3), which adds up to 100 wt %.

The polyols, polyamines or mixtures of polyols and/or polyamines of component B1) preferably have an average functionality of 3 to 6 and more preferably of 3.5 to 5.5.

Preferred polyols or polyamines for component B1) are selected from the group consisting of sugars (sorbitol, glucose, sucrose), pentaerythritol, sorbitol, trimethylolpropane, glycerol, tolylenediamine, ethylenediamine, ethylene glycols, propylene glycol and water. Particular preference is given to sugars (sorbitol, glucose, sucrose), glycerol, water and ethylene glycols and also mixtures thereof with especial preference being given to mixtures comprising two or more compounds selected from sucrose, glycerol, water and diethylene glycol.

In one advantageous embodiment, component B1) comprises a mixture of glycerol and sucrose.

The proportion contributed by component B1) to the weight amount of components B1) to B3) is moreover more preferably in the range from 15 to 63 wt %, especially in the range from 20 to 55 wt % and even more preferably in the range from 23 to 30 wt %.

In general, the fatty acid or fatty acid monoester B2) is selected from the group consisting of polyhydroxy fatty acids, ricinoleic acid, hydroxyl-modified oils, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, stearic acid, arachidonic acid, timnodonic acid, clupanodonic acid and cervonic acid. The methyl esters are preferred fatty acid monoesters.

In one preferred embodiment of the present invention, the fatty acids or fatty acid monoesters B2) are used in the form of fatty acid methyl esters, biodiesel or pure fatty acids. Preference is given to biodiesel and pure fatty acids, especial preference is given to pure fatty acids, preferably oleic acid and stearic acid, especially in particular oleic acid.

In a further preferred embodiment of the present invention, the fatty acid or fatty acid monoester B2) is oleic acid or stearic acid or a derivative thereof, particular preference being given to oleic acid, methyl oleate, stearic acid and methyl stearate. The fatty acid or fatty acid monoester generally serves to improve the blowing agent solubility in the production of polyurethane foams.

The proportion contributed by component B2) to the overall amount of components B1) to B3) is particularly preferably in the range from 2 to 30 wt %, especially from 5 to 25 wt %, even more preferably from 8 to 20 wt % and especially from 12 to 17 wt %.

Examples of suitable alkylene oxides B3) having 2 to 4 carbon atoms are tetrahydrofuran, 1,3-propylene oxide, 1,2-butylene oxide, 2,3-butyleneoxid, styrene oxide and preferably ethylene oxide and 1,2-propylene oxide. The alkylene oxides can be used individually, alternatingly in succession or as mixtures. Preferred alkylene oxides are propylene oxide and ethylene oxide, particular preference is given to mixtures of ethylene oxide and propylene oxide comprising not less than 35 wt % of propylene oxide, and especial preference is given to pure propylene oxide.

The reaction to obtain component B) is preferably carried out in the presence of an alkoxylation catalyst. In one preferred embodiment, the alkoxylation catalyst used is an amine, especially N,N-dimethylethanolamine or imidazoles. Imidazole is particularly preferred.

The proportion which alkylene oxides contribute to the overall amount of component B) is generally in the range from 35 to 83 wt %, preferably in the range from 40 to 75 wt % and more preferably in the range from 50 to 65 wt %.

The fatty acid modified polyetherpolyols which are used according to the present invention as part of component B) preferably have an OH number in the range from 200 to 700 mg KOH/g, especially from 300 to 600 mg KOH/g, more preferably from 350 to 500 mg KOH/g and even more preferably from 380 to 480 mg KOH/g. The average functionality of the fatty acid modified polyetherpolyols used according to the present invention is generally in the range from 2.5 to 8, preferably in the range from 3 to 6, more preferably in the range from 3.5 to 5.5 and especially in the range from 4 to 5. The viscosity of fatty acid modified polyetherpolyols used according to the present invention is generally <10 000 mPa*s, preferably <7000 mPa*s, more preferably <5000 mPa*s and specifically <4500 mPa*s, all measured at 25° C. to DIN 53018.

Especially the use of methyl oleate as component B2) leads to a low viscosity on the part of the resulting polyol component B) to H).

The proportion attributable to the fatty acid modified polyetherpolyols B) used according to the present invention is generally >20 wt %, preferably >30 wt %, more preferably >40 wt % and even more preferably >45 wt %, based on total components B) to H).

The proportion attributed to the fatty acid modified polyetherpolyols B) of the present invention is generally <90 wt %, preferably <80 wt %, more preferably <70 wt % and even more preferably <65 wt %, based on total components B) to H).

Component C

According to the present invention, component C) consists of one or more polyetherpolyols obtainable via a process comprising steps c1) and c2). Polyetherpolyols differ from fatty acid modified polyetherpolyols in being compounds that have at least one ether linkage plus at least reactive hydroxyl groups, but no ester linkage.

The polyetherpolyols C) used according to the present invention are thus obtained in an at least two-step process in which the at least two steps differ in the composition of the alkylene oxides used. At least the second step c2) takes place in the presence of an alkoxylation catalyst, hereinafter referred to as catalyst. The catalyst is preferably added following step c1), i.e., the reaction as per step c1) preferably takes place in the absence of a catalyst.

Suitable catalysts are in particular alkali metal hydroxides, such as sodium hydroxide or potassium hydroxide, or alkali meal alkoxides, such as sodium methoxide, sodium ethoxide, potassium ethoxide or potassium isopropoxide. Suitable catalysts also include aminic alkoxylation catalysts, especially dimethylethanolamine (DMEOA), imidazole and imidazole derivatives and also mixtures thereof.

Preferred alkoxylation catalysts are KOH and aminic alkoxylation catalysts. Use of aminic alkoxylation catalysts is particularly preferred, since when KOH is used as alkoxylation catalyst, the polyether first has to be neutralized and the resultant potassium salt has to be separated off. Preferred aminic alkoxylation catalysts are selected from the group comprising dimethylethanolamine (DMEOA), imidazole and imidazole derivatives and also mixtures thereof, more preferably imidazole.

According to the present invention, component C) is obtainable using alongside orthotolylene further co-starters, which differ from ortho-tolylenediamine. ortho-Tolylenediamine (o-TDA) is synonymous with vicinal-tolylenediamine (vic-TDA) and comprises the isomers 2,3-TDA, 3,4-TDA and mixtures thereof. The level of meta-TDA possibly present in residual amounts in the TDA used is preferably less than 20 wt %, more preferably less than 10 wt % and even more preferably less than 5 wt % based on the weight amount of the starter TDA (remainder: ortho-TDA).

Examples of possible further co-starter molecules are: water, organic dicarboxylic acids, such as succinic acid, adipic acid, phthalic acid and terephthalic acid, aliphatic and aromatic, optionally N-monoalkyl-, N,N-dialkyl- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,4- and 2,6-tolylenediamine and 4,4′-, 2,4′- and 2,2′-diaminodiphenylmethane.

Useful further co-starter molecules further include: alkanolamines, for example ethanolamine, N-methylethanolamine and N-ethylethanolamine, dialkanolamines, for example diethanolamine, N-methyldiethanolamine and N-ethyldiethanolamine, and trialkanolamines, for example triethanolamine, and ammonia. Preference is given to using dihydric or polyhydric alcohols, such as ethanediol, 1,2-propandiol, 1,3-propanediol, diethylene glycol, dipropylene glycol, 1,4-butanediol, 1,6-hexanediol, glycerol, trimethylolpropane, pentaerythritol, sorbitol and sucrose. The abovementioned primary amines are preferred.

The starter used for component C) is preferably ortho-TDA exclusively. When further co-starters are used, this is preferably in an amount of 0.001 to 20 wt %, preferably in an amount of 0.01 to 10 wt %, based on the overall amount of all starters used for preparing component C).

According to the present invention, step c1) comprises reacting orthotolylenediamine with at least one alkylene oxide comprising ethylene oxide wherein the ethylene oxide content is more than 20 wt %, based on the weight amount of alkylene oxides reacted in step c1), and then step c2) comprises reacting the reaction product from step c1) with at least one alkylene oxide comprising propylene oxide wherein the 1,2-propylene oxide content is more than 20 wt %, based on the weight amount of alkylene oxides used in step c2), with step c2) being effected in the presence of a catalyst.

For step c1), the ethylene oxide content is preferably in the range from 40 to 100 wt % based on the weight amount of all alkylene oxides reacted in step c1), especially in the range from 50 to 100 wt %, more preferably in the range from 60 to 100 wt %, even more preferably in the range from 70 to 100 wt % and yet even more preferably equal to 100 wt %; that is, it is very particularly preferable to react exclusively ethylene oxide in the context of step c1). The weight quantity complementary to 100 wt % is preferably 1,2-propylene oxide.

For step c2), the 1,2-propylene oxide content is preferably in the range from 40 to 100 wt % based on the weight amount of all alkylene oxides reacted in step c2), especially in the range from 50 to 100 wt %, more preferably in the range from 60 to 100 wt %, even more preferably in the range from 70 to 100 wt % and yet even more preferably equal to 100 wt %; that is, it is very particularly preferable to react exclusively 1,2-propylene oxide in the context of step c2). The weight quantity complementary to 100 wt % is preferably ethylene oxide.

In addition to the recited alkylene oxides ethylene oxide in step c1) and 1,2-propylene oxide in step c2), further alkylene oxides can be reacted not only in step c1) but also in step c2) provided the mixing ratios that are in accordance with the present invention or preferred are observed.

Examples of suitable further alkylene oxides are tetrahydrofuran, 1,3-propylenoxide, 1,2-butylene oxide, 2,3-butylene oxide, styrene oxide and preferably ethylene oxide and 1,2-propylene oxide. The alkylene oxides can be used individually, alternatingly in succession or as mixtures. The stated mixing ratios relate to the overall weight of the alkylene oxides reacted in the context of the particular step. Alkylene oxides preferred for component C) have from 2 to 6 carbon atoms, especially from 2 to 4.

The entire ethylene oxide proportion of the polyetherols used in the context of component C) is generally >2 wt %, preferably >5 wt %, more preferably >10 wt % and especially >12.5 wt % based on the proportion of the entire alkylene oxide. The ethylene oxide proportion of the polyetherpolyols used in the context of component C) is generally <90 wt %, preferably <70 wt %, more preferably <50 wt % and especially <30 wt %, all based on the entire weight amount of all reacted alkylene oxides. It is very particularly preferred to use exclusively ethylene oxide and 1,2-propylene oxide as alkylene oxide in the context of component C).

The polyetherpolyols used in the context of component C) preferably have a functionality of preferably 2 to 6 and especially from 2 to 5 and number-average molecular weights of preferably 150 to 3000, more preferably from 200 to 1500 and especially from 250 to 750. The OH number of polyetherpolyols for component C) is preferably from 800 to 150, preferably from 600 to 250 and especially from 500 to 300 mg KOH/g.

The proportion of component C) is generally from 1 to 50 wt %, preferably from 2 to 40 wt % and more preferably from 5 to 30 wt % based on total components B) to H).

Component D

According to the present invention, component D) optionally comprises one or more polyols other than those of components B) and C). Especially polyetherpolyols and polyesterpolyols are useful as polyols D).

Suitable polyesterpolyols differ from the fatty acid modified polyetherpolyols B) and are obtainable for example from organic dicarboxylic acids having 2 to 12 carbon atoms, preferably aromatic ones, or mixtures of aromatic and aliphatic dicarboxylic acids, and polyhydric alcohols, preferably diols, having 2 to 12 carbon atoms and preferably 2 to 6 carbon atoms.

Possible dicarboxylic acids are, in particular: succinic acid, glutaric acid, adipic acid, suberic acid, azelaic acid, sebacic acid, decanedicarboxylic acid, maleic acid, fumaric acid, phthalic acid, isophthalic acid and terephthalic acid. It is likewise possible to use derivatives of these dicarboxylic acids, such as dimethyl terephthalate, for example. The dicarboxylic acids can be used either individually or in admixture with one another. It is also possible to use the corresponding dicarboxylic acid derivatives, e.g. dicarboxylic esters of alcohols having from 1 to 4 carbon atoms or dicarboxylic anhydrides, in place of the free dicarboxylic acids. As aromatic dicarboxylic acids, preference is given to using phthalic acid, phthalic anhydride, terephthalic acid and/or isophthalic acid as a mixture or alone. As aliphatic dicarboxylic acids, preference is given to using dicarboxylic acid mixtures of succinic, glutaric and adipic acid in weight ratios of, for example, 20-35:35-50:20-32 parts by weight and in particular adipic acid. Examples of dihydric and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, trimethylolpropane and pentaerythritol. Preference is given to using ethanediol, diethylene glycol, 1,4-butanediol, 1,5-pentanediol, 1,6-hexanediol or mixtures of at least two of the diols mentioned, in particular mixtures of 1,4-butanediol, 1,5-pentanediol and 1,6-hexanediol. It is also possible to use polyester polyols derived from lactones, e.g., ε-caprolactone, or hydroxycarboxylic acids, e.g., ω-hydroxycaproic acid.

To prepare further polyesterpolyols for component D), biobased starting materials and/or derivatives thereof are also suitable, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified fatty acids and fatty acid esters based on myristoleic acid, palmitoleic acid, oleic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

One especially preferred embodiment does not utilize any polyesterpolyols in the context of component D).

Component D) may also alternatively or additionally utilize one or more polyetherpolyols. Polyetherols D) can be prepared by known methods, for example by anionic polymerization of one or more alkylene oxides having from 2 to 4 carbon atoms using alkali metal hydroxides, e.g., sodium or potassium hydroxide, or alkali metal alkoxides, e.g., sodium methoxide, sodium or potassium ethoxide or potassium isopropoxide, or aminic alkoxylation catalysts, such as dimethylethanolamine (DMEOA), imidazole and/or imidazole derivatives, with use of at least one starter molecule comprising from 2 to 8, preferably from 2 to 6, reactive hydrogen atoms in bonded form, or by cationic polymerization using Lewis acids, e.g., antimony pentachloride, boron fluoride etherate, or bleaching earth.

Examples of suitable alkylene oxides are tetrahydrofuran, 1,3-propylene oxide, 1,2-butylene oxide, 2,3-butylene oxide, styrene oxide and preferably ethylene oxide and 1,2-propylene oxide. The alkylene oxides can be used individually, alternatingly in succession or as mixtures. Preferred alkylene oxides are propylene oxide and ethylene oxide, while propylene oxide is particularly preferred.

Examples of possible starter molecules include: water, organic dicarboxylic acids, such as succinic acid, adipic acid, phthalic acid and terephthalic acid, aliphatic and aromatic, optionally N-monoalkyl-, N,N-dialkyl- and N,N′-dialkyl-substituted diamines having from 1 to 4 carbon atoms in the alkyl radical, e.g. optionally monoalkyl- and dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamines, 2,4- and 2,6-tolylenediamine and 4,4′-, 2,4′- and 2,2′-diaminodiphenylmethane. Particular preference is given to the recited diprimary amines, for example ethylenediamine.

Further possible starter molecules are: alkanolamines such as ethanolamine, N-methylethanolamine and N-ethylethanolamine, dialkanolamines, such as diethanolamine, N-methyldiethanolamine and N-ethyldiethanolamine and trialkanolamines, e.g., triethanolamine, and ammonia.

Preference is given to using dihydric or polyhydric alcohols, e.g., ethanediol, 1,2- and 1,3-propanediol, diethylene glycol (DEG), dipropylene glycol, 1,4-butanediol, 1,6-hexanediol, glycerol, trimethylolpropane, pentaerythritol, sorbitol and sucrose.

The proportion of component D) is generally in the range from 0 to 35 wt %, preferably in the range from 0 to 25 wt % and more preferably in the range from 0 to 15 wt %, based on total components B) to H). It is very particularly preferable not to use any further polyol D) at all; that is, the proportion of the polyol component which is attributable to component D) is most preferably 0 wt %.

Component E

As flame retardants E), it is generally possible to use the flame retardants known from the prior art. Suitable flame retardants are, for example, brominated esters, brominated ethers (Ixol) or brominated alcohols such as dibromoneopentyl alcohol, tribromoneopentyl alcohol and PHT-4-diol and also chlorinated phosphates such as tris(2-chloroethyl)phosphate, tris(2-chloropropyl)phosphate (TCPP), tris(1,3-dichloropropyl)phosphate, tricresyl phosphate, tris(2,3-dibromopropyl)phosphate, tetrakis(2-chloroethyl)ethylenediphosphate, dimethyl methanephosphonate, diethyl diethanolaminomethylphosphonate and also commercial halogen-comprising flame retardant polyols. By way of further phosphates or phosphonates it is possible to use diethyl ethanephosphonate (DEEP), triethyl phosphate (TEP), dimethyl propylphosphonate (DMPP) or diphenyl cresyl phosphate (DPK) as liquid flame retardants.

Apart from the abovementioned flame retardants, it is also possible to use inorganic or organic flame retardants such as red phosphorus, preparations comprising red phosphorus, aluminum oxide hydrate, antimony trioxide, arsenic oxide, ammonium polyphosphate and calcium sulfate, expandable graphite or cyanuric acid derivatives such as melamine, or mixtures of at least two flame retardants, e.g. ammonium polyphosphates and melamine and optionally maize starch or ammonium polyphosphate, melamine, expandable graphite and optionally aromatic polyesters for making the rigid polyurethane foams flame resistant.

Preferable flame retardants have no isocyanate-reactive groups. The flame retardants are preferably liquid at room temperature. Particular preference is given to TCPP, DEEP, TEP, DMPP and DPK.

The proportion of flame retardant E) is generally in the range from 0 to 30 wt %. Component E) is preferably used in a proportion of not less than 1 wt % and more preferably not less than 5 wt %, based on total components B) to H). On the other hand, component E) is preferably used in a proportion of not more than 20 wt % and more preferably of not more than 15 wt % based on total components B) to H).

Component F

Blowing agents F) which are used for producing the rigid polyurethane foams include preferably water, formic acid and mixtures thereof. These react with isocyanate groups to form carbon dioxide and in the case of formic acid carbon dioxide and carbon monoxide. Since these blowing agents release the gas through a chemical reaction with the isocyanate groups, they are termed chemical blowing agents. In addition, physical blowing agents such as low-boiling hydrocarbons can be used. Suitable in particular are liquids which are inert towards the polyisocyanates A) and have boiling points below 100° C., preferably below 50° C., at atmospheric pressure, so that they vaporize under the conditions of the exothermic polyaddition reaction. Examples of such liquids which can preferably be used are alkanes such as heptane, hexane, n-pentane and isopentane, preferably industrial mixtures of n-pentane and isopentane, n-butane and isobutane and propane, cycloalkanes such as cyclopentane and/or cyclohexane, ethers such as furan, dimethyl ether and diethyl ether, ketones such as acetone and methyl ethyl ketone, alkyl carboxylates such as methyl formate, dimethyl oxalate and ethyl acetate and halogenated hydrocarbons such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. Mixtures of these low-boiling liquids with one another and/or with other substituted or unsubstituted hydrocarbons can also be used. Organic carboxylic acids such as formic acid, acetic acid, oxalic acid, ricinoleic acid and carboxyl-containing compounds are also suitable.

It is preferable not to use any halogenated hydrocarbons as blowing agents. It is preferable to use water, formic acid-water mixtures or formic acid as chemical blowing agents and formic acid-water mixtures or water are particularly preferred chemical blowing agents. Pentane isomers, especially n-pentane and/or cyclopentane, or mixtures of pentane isomers are preferably used as physical blowing agents.

It is very particularly preferable for the blowing agents of component F) to be selected from the group consisting of water, formic acid and pentane, especially from the group consisting of water and pentane. A mixture of water and pentane is expressly preferred for use as component F).

The blowing agents are either wholly or partly dissolved in the polyol component (i.e. B+C+D+E+F+G+H) or are introduced via a static mixer immediately before foaming of the polyol component. It is usual for water, formic acid-water mixtures or formic acid to be fully or partially dissolved in the polyol component and the physical blowing agent (for example pentane) and any remainder of the chemical blowing agent to be introduced on-line, i.e., immediately prior to producing the rigid foam.

The polyol component is admixed in situ with pentane, possibly some of the chemical blowing agent and also with all or some of the catalyst. Auxiliary and admixture agents as well as flame retardants are already comprised in the polyol blend.

The amount of blowing agent or blowing agent mixture used is in the range from 1 to 45 wt %, preferably in the range from 1 to 30 wt % and more preferably in the range from 1.5 to 20 wt %, all based on total components B) to H).

When water, formic acid or a formic acid-water mixture is used as blowing agent, it is preferably added to the polyol component (B+C+D+E+F+G+H) in an amount of 0.2 to 10 wt %, based on component B). The addition of water, formic acid or formic acid-water mixture can take place in combination with the use of other blowing agents described. Preference is given to using water or a formic acid-water mixture in combination with pentane.

Component G

Catalysts G) used for preparing the rigid polyurethane foams are particularly compounds which substantially hasten the reaction of the components B) to H) compounds comprising reactive hydrogen atoms, especially hydroxyl groups, with the polyisocyanates A).

It is advantageous to use basic polyurethane catalysts, for example tertiary amines such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methylmorpholine or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis(2-dimethylaminoethyl)ether, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyldiethanolamine and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, and triethylenediamine. However, metal salts such as iron(II) chloride, zinc chloride, lead octoate and preferably tin salts such as tin dioctoate, tin diethylhexoate and dibutyltin dilaurate and also, in particular, mixtures of tertiary amines and organic tin salts are also suitable.

Further possible catalysts are: amidines such as 2,3-dimethyl-3,4,5,6-tetrahydropyrimidine, tetraalkylammonium hydroxides such as tetramethylammonium hydroxide, alkali metal hydroxides such as sodium hydroxide and alkali metal alkoxides such as sodium methoxide and potassium isopropoxide, alkali metal carboxylates and also alkali metal salts of long-chain fatty acids having from 10 to 20 carbon atoms and optionally lateral OH groups. Preference is given to using from 0.001 to 10 parts by weight of catalyst or catalyst combination, based (i.e., reckoned) on 100 parts by weight of component B). It is also possible to allow the reactions to proceed without catalysis. In this case, the catalytic activity of amine-started polyols is exploited.

When, during foaming, a relatively large polyisocyanate excess is used, further suitable catalysts for the trimerization reaction of the excess NCO groups with one another are: catalysts which form isocyanurate groups, for example ammonium ion salts or alkali metal salts, specifically ammonium or alkali metal carboxylates, either alone or in combination with tertiary amines. Isocyanurate formation leads to flame-resistant PIR foams which are preferably used in industrial rigid foam, for example in building and construction as insulation boards or sandwich elements.

The catalysts are advantageously used in the smallest effective amount. The proportion of the overall amount of components B) to H) which is attributable to component G) is preferably in the range from 0.001 to 15 wt % and especially from 0.01 to 10 wt % all based on the weight amount of components B) to H).

Further information regarding the abovementioned and further starting materials may be found in the technical literature, for example Kunststoffhandbuch, Volume VII, Polyurethane, Carl Hanser Verlag Munich, Vienna, 1st, 2nd and 3rd Editions 1966, 1983 and 1993.

Component H

Further auxiliaries and/or admixture agents H) can optionally be added to the reaction mixture for producing the rigid polyurethane foams. Mention may be made of, for example, surface-active substances, foam stabilizers, cell regulators, fillers, dyes, pigments, hydrolysis inhibitors, fungistatic and bacteriostatic substances.

Possible surface-active substances are, for example, compounds which serve to aid homogenization of the starting materials and may also be suitable for regulating the cell structure of the polymers. Mention may be made of, for example, emulsifiers such as the sodium salts of castor oil sulfates or of fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzenedisulfonic or dinaphthylmethanedisulfonic acid and ricinoleic acid; foam stabilizers such as siloxane-oxyalkylene copolymers and other organopolysiloxanes, ethoxylated alkylphenols, ethoxylated fatty alcohols, paraffin oils, castor oil esters or ricinoleic esters, Turkey red oil and peanut oil, and cell regulators such as paraffins, fatty alcohols and dimethylpolysiloxanes. The above-described oligomeric acrylates having polyoxyalkylene and fluoroalkane radicals as side groups are also suitable for improving the emulsifying action, the cell structure and/or for stabilizing the foam. The surface-active substances are usually employed in amounts of from 0.01 to 10 parts by weight, preferably 0.01 to 5 parts by weight, based on the weight of components B) to H).

Fillers, in particular reinforcing fillers, are the customary organic and inorganic fillers, reinforcing materials, weighting agents, agents for improving the abrasion behavior in paints, coating compositions, etc., which are known per se. Specific examples are: inorganic fillers such as siliceous minerals, for example sheet silicates such as antigorite, serpentine, horn blendes, amphiboles, chrisotile and talc, metal oxides such as kaolin, aluminum oxides, titanium oxides and iron oxides, metal salts, such as chalk, barite and inorganic pigments such as cadmium sulfide and zinc sulfide and also glass, etc. Preference is given to using kaolin (china clay), aluminum silicate and coprecipitates of barium sulfate and aluminum silicate and also natural and synthetic fibrous minerals such as wollastonite, metal fibers and in particular glass fibers of various length, which may be coated with a size. Possible organic fillers are, for example: carbon, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are advantageously added to the reaction mixture in amounts of from 0.5 to 50 wt %, preferably from 1 to 40 wt %, based on the weight of components B) to H), although the content of mats, nonwovens and woven fabrics of natural and synthetic fibers can reach values of up to 80 wt %, based on the weight of components B) to H).

Further information regarding the abovementioned other customary auxiliary and admixture agents may be found in the technical literature, for example the monograph by J. H. Saunders and K. C. Frisch “High Polymers” Volume XVI, Polyurethanes, Parts 1 and 2, Interscience Publishers 1962 and 1964, or Kunststoff-Handbuch, Polyurethane, Volume VII, Hanser-Verlag, Munich, Vienna, 1st and 2nd Editions, 1966 and 1983.

The polyol component of the present invention preferably consists of the following components:

20 to 90 wt % of component B),

1 to 50 wt % of component C),

0 to 35 wt % of component D),

0 to 30 wt % of component E),

optionally 1 to 45 wt % of component F),

0.001 to 15 wt % of component G), and

0.01 to 10 wt % of component H),

all as defined above and all based on the total weight of components B) to H), wherein the wt % add up to 100 wt %.

It is particularly preferable for the polyol component of the present invention to consist of

30 to 70 wt % of component B),

2 to 40 wt % of further component C),

0 to 25 wt % of component D),

1 to 20 wt % of component E),

optionally 1 to 30 wt % of component F),

0.01 to 10 wt % of component G), and

0.01 to 5 wt % of component H),

all as defined above and all based on the total weight of components B) to H), wherein the wt % add up to 100 wt %.

It is particularly preferable for the proportion of component D) to be 0 wt %.

To produce the rigid polyurethane foams of the present invention, the organic polyisocyanates A), the fatty acid modified polyetherpolyols B), the specific polyesterpolyols C), optionally the polyetherols D) and the further components E) to H) are mixed in such amounts that the equivalence ratio of NCO groups of the polyisocyanates A) to the sum of the reactive hydrogen atoms of components B), optionally C) and also D) to H) is from 1 to 6:1, preferably from 1.05 to 2.5:1 and especially from 1.1 to 1.8:1.

The rigid polyurethane foams are advantageously produced by the one-shot process, for example using high-pressure or low-pressure technology in open or closed molds, for example metallic molds. It is also customary to apply the reaction mixture to suitable belt lines in a continuous manner to produce panels.

The starting components are, at a temperature from 15 to 90° C., preferably from 20 to 60° C. and especially from 20 to 35° C., mixed and introduced into the open mold or, if necessary under superatmospheric pressure, into the closed mold, or applied in a continuous workstation to a belt for receiving the reactive material. Mixing, as already noted, can be carried out mechanically using a stirrer or a stirring screw. Mold temperature is advantageously in the range from 20 to 110° C., preferably in the range from 30 to 70° C. and especially in the range from 40 to 60° C.

The rigid polyurethane foams produced by the process of the present invention have a density of 15 to 300 g/l, preferably of 20 to 100 g/l and especially of 25 to 60 g/l.

### EXAMPLES

Some examples are given hereinbelow to illustrate the invention. Because these examples merely have illustrative purposes, they are not in any way intended to restrict the scope of the claims.

Fatty Acid Modified Polyetherpolyol 1

42.5 kg of glycerol, 0.2 kg of imidazole, 68.7 g of sucrose and also 54.0 kg of biodiesel were initially charged to a reactor at 25° C. The reactor was subsequently inertized with nitrogen. The tank was heated to 130° C. and 234.5 kg of propylene oxide were metered in. Following a reaction time of 2 h, the reactor was evacuated at 100° C. for 60 minutes under full vacuum and then cooled down to 25° C. 382 g of product were obtained.

The fatty acid modified polyetherpolyol 1 obtained had the following characteristic values: OH number: 414.0 mg KOH/g; viscosity, DIN 53018 (25° C.): 3720 mPa·s; acid number: below 0.001 mg KOH/g; water content: 0.007%.

Polyetherpolyol 1

99.6 kg of vic-tolylenediamine were initially charged to a reactor at 25° C. The reactor was subsequently inertized with nitrogen. The tank was heated to 140° C. and a mixture of 68.4 kg of ethylene oxide and 47.5 kg of propylene oxide was metered in. Following a reaction time of 4 h, the reactor was evacuated for 90 minutes under full vacuum while at the same time the temperature was reduced to 25° C. Then, at 25° C., 2.1 kg of 50% aqueous KOH solution were added and another inertization with nitrogen was carried out. The tank was heated to 140° C. and a further 232.8 kg of propylene oxide were metered in. Following a reaction time of 1 h the reactor was evacuated for 90 minutes under full vacuum and then cooled down to 25° C. to obtain 397.0 kg of product.

The resulting “polyetherpolyol 1” had the following characteristic values: OH number: 402.5 mg KOH/g; viscosity, DIN 53018 (25° C.): 13292 mPas; acid number: below 0.01 mg KOH/g; water content: below 0.01%.

Polyetherpolyol 2 (Comparator)

113 kg of vic-tolylenediamine were initially charged to a reactor at 25° C. The reactor was subsequently inertized with nitrogen. The tank was heated to 138° C. and 150 kg of propylene oxide were metered in. Following a reaction time of 2 h, the temperature was lowered to 95° C., 0.44 kg of imidazole was added and another inertization with nitrogen was carried out. Then, at 95° C., a further 234.8 kg of propylene oxide were metered in. Following a reaction time of 3 h the reactor was evacuated for 90 minutes under full vacuum and then cooled down to 25° C. to obtain 453 kg of product.

The resulting “polyetherpolyol 2” had the following characteristic values: OH number: 403.0 mg KOH/g; viscosity, DIN 53018 (25° C.): 40948 mPa·s; acid number: below 0.01 mg KOH/g; water content: below 0.01%.

### Comparative Example 1

Starting with 61.65 parts by weight of the fatty acid modified polyetherpolyol 1, 20.0 parts by weight of polyetherpolyol 2 (comparator), 15.0 parts by weight of tris-2-chloroisopropyl phosphate (TCPP), 2.0 parts by weight of silicone-containing foam stabilizer (Tegostab® B 8443 from Goldschmidt), 0.5 part by weight of a 50 wt % solution of potassium acetate in ethylene glycol and 0.85 part by weight of water, a polyol component was obtained by mixing.

The polyol component was phase-stable at 20° C. It was reacted with a polymer MDI having an NCO content of 31.5 wt % (Lupranat® M50 from BASF SE) in the presence of n-pentane (7.5 parts by weight), dimethylcyclohexylamine and water at an isocyanate index of 131. The amounts of dimethylcyclohexylamine and water were selected such that the fiber time was 45±1 seconds and the resulting foam had a density of 37±1 kg/m³.

### Comparative Example 2

Starting with 66.65 parts by weight of the fatty acid modified polyetherpolyol 1, 15.0 parts by weight of polyetherpolyol 2 (comparator), 15.0 parts by weight of tris-2-chloroisopropyl phosphate (TCPP), 2.0 parts by weight of silicone-containing foam stabilizer (Tegostab® B 8443 from Goldschmidt), 0.5 part by weight of a 50 wt % solution of potassium acetate in ethylene glycol and 0.85 part by weight of water, a polyol component was obtained by mixing.

The polyol component was phase-stable at 20° C. It was reacted with a polymer MDI having an NCO content of 31.5 wt % (Lupranat® M50 from BASF SE) in the presence of n-pentane (7.5 parts by weight), dimethylcyclohexylamine and water at an isocyanate index of 132. The amounts of dimethylcyclohexylamine and water were selected such that the fiber time was 45±1 seconds and the resulting foam had a density of 37±1 kg/m³.

### Example 1

Starting with 61.65 parts by weight of the fatty acid modified polyetherpolyol 1, 20.0 parts by weight of polyetherpolyol 1, 15.0 parts by weight of tris-2-chloroisopropyl phosphate (TCPP), 2.0 parts by weight of silicone-containing foam stabilizer (Tegostab® B 8443 from Goldschmidt), 0.5 part by weight of a 50 wt % solution of potassium acetate in ethylene glycol and 0.85 part by weight of water, a polyol component was obtained by mixing.

The polyol component was phase-stable at 20° C. It was reacted with a polymer MDI having an NCO content of 31.5 wt % (Lupranat® M50 from BASF SE) in the presence of n-pentane (7.5 parts by weight), dimethylcyclohexylamine and water at an isocyanate index of 132. The amounts of dimethylcyclohexylamine and water were selected such that the fiber time was 45±1 seconds and the resulting foam had a density of 37±1 kg/m³.

### Example 2

Starting with 66.65 parts by weight of the fatty acid modified polyetherpolyol 1, 15.0 parts by weight of polyetherpolyol 1, 15.0 parts by weight of tris-2-chloroisopropyl phosphate (TCPP), 2.0 parts by weight of silicone-containing foam stabilizer (Tegostab® B 8443 from Goldschmidt), 0.5 part by weight of a 50 wt % solution of potassium acetate in ethylene glycol and 0.85 part by weight of water, a polyol component was obtained by mixing.

The polyol component was phase-stable at 20° C. It was reacted with a polymer MDI having an NCO content of 31.5 wt % (Lupranat® M50 from BASF SE) in the presence of n-pentane (7.5 parts by weight), dimethylcyclohexylamine and water at an isocyanate index of 132. The amounts of dimethylcyclohexylamine and water were selected such that the fiber time was 45±1 seconds and the resulting foam had a density of 37±1 kg/m³.

Measurement of Brittleness

Brittleness was measured using the bolt test. The measurement was done 3, 4, 5 and 6 minutes after starting to mix 80 g of reaction mixture of components A to H in a polypropylene beaker having a capacity of 1.15 L.

A steel bolt with a spherical cap 10 mm in radius was pressed 10 mm deep into the resultant foam mushroom at a test speed of 100 mm/minute. Each measurement was made at a different place equidistant from the center of the foam surface. Any tearing of the foam surface in the course of the measurement was noted.

Measurement of Needle Height

80 g of the reaction mixture of components A to H were mixed in a 0.735 L capacity cardboard beaker. At the time set for the fiber time, a pin was pressed into the foam from the upper rim of the beaker. After the polyurethane foam mushroom had fully risen, the length difference between beaker rim and needle was read off on a ruler.

Measurement of Viscosity

Viscosities were measured similarly to DIN 53018 at 20° C.

Measurement of Flowability

A transparent nylon hose rolled up flat was used. The hose had a width of 7.0 cm in the flat state and a diameter of 4.5 cm in the open state. To fill it with the reaction mixture, the hose was uncoiled for about 100 cm and secured to a stand about 30 cm above the laboratory bench. A wide-neck funnel sitting in the upper end of the hose opening was used to effect simple filling, while a cable binder at a short distance underneath the funnel made it possible to close the hose airtight immediately after filling.

For the measurement, 100 g of the reaction mixture of components A to H were thoroughly mixed in a 0.735 L capacity cardboard cup at 1500 rpm for 7 seconds and immediately thereafter tipped into the hose for 10 seconds. The open side of the hose was then immediately closed with the cable binder, so the expanding foam was forced to flow through the flat hose in the direction of the coil. Immediately thereafter, the beaker with the remaining reaction mixture was reweighed in order to determine the exact amount of material in the hose. After full expansion of the foam, the flow path covered was recorded in cm.

These data can be used to calculate the theoretical hose length as follows:

$$Theoretical hose length [ cm ] = \frac{100 g \times flow path [ cm ]}{Amount of materialinhose [ g ]}$$

The results of the tests are summarized in table 1:

TABLE 1

| | | Com- | | Com- |
|---|---|---|---|---|
| | | parative | | parative |
| | Example 1 | Example 1 | Example 2 | Example 2 |
| Fatty acid modified | 61.65 | 61.65 | 66.65 | 66.65 |
| polyetherpolyol 1 | | | | |
| Polyetherpolyol 1 | 20 | | 15 | |
| Polyetherpolyol 2 | | 20 | | 15 |
| (comparator) | | | | |
| TCPP | 15 | 15 | 15 | 15 |
| Tegostab B 8443 | 2 | 2 | 2 | 2 |
| 50 wt % of solution | 0.5 | 0.5 | 0.5 | 0.5 |
| of potassium acetate | | | | |
| in ethylene glycol | | | | |
| Water | 0.85 | 0.85 | 0.85 | 0.85 |
| Fiber time [s] | 46 | 45 | 45 | 46 |
| Apparent density [kg/m³] | 37.1 | 36.8 | 37.0 | 36.7 |
| Viscosity of polyol | 3160 | 3570 | 3000 | 3300 |
| component, 20° C. | | | | |
| [mPa * s] | | | | |
| Needle height [cm] | 2.3 | 2.5 | 2.3 | 2.5 |
| Theoretical foam | 138 | 134 | 137 | 135 |
| length [cm] | | | | |
| Crack in surface | no | yes | no | no |
| after 3.0 min | | | | |
| Crack in surface | no | yes | no | yes |
| after 4.0 min | | | | |
| Crack in surface | yes | yes | yes | yes |
| after 5.0 min | | | | |
| Crack in surface | yes | yes | yes | yes |
| after 6.0 min | | | | |

Comparative Examples 1 and 2 represent commonly used formulations known from the prior art.

Example 1 and Example 2 surprisingly display a lower needle height than Comparative Example 1 and Comparative Example 2. Needle height is a measure of post-expansion of the foam after setting. Low needle heights are advantageous for the compressive strength in the rise direction in the continuous processing to composite elements having rigid outer layers for example, since the cells in the rise direction are in a less compressed state than at greater needle heights.

Example 1 and Example 2 surprisingly also display less brittleness than Comparative Example 1 and Comparative Example 2, which shows itself in the test in the form of later tearing of the surface.

The systems obtained from Example 1 and Example 2 also surprisingly display slightly higher values in theoretical hose length than systems obtained from Comparative Example 1 and Comparative Example 2. Theoretical hose length characterizes the flow of the material of the expanding foam. Higher values are generally advantageous, since complete foam filling of moldings is easier.

Example 1 and Example 2 versus Comparative Example 1 and Comparative Example 2 display viscosities which can be processed on conventional double belt machines without mixing problems.

1. A process for producing a rigid polyurethane foam or a rigid polyisocyanurate foam, the process comprising reacting
A) at least one polyisocyanate,
B) at least one fatty acid modified polyetherpolyol,
C) at least one polyetherpolyol,
D) optionally one or more polyols other than those of components B) and C),
E) optionally one or more flame retardants,
F) one or more blowing agents,
G) one or more catalysts, and
H) optionally a further auxiliary, admixture agent, or both,
wherein component C) is obtained by a process comprising
c1) reacting orthotolylenediamine and optionally one or more further co-starters with at least one alkylene oxide comprising ethylene oxide wherein an ethylene oxide content is more than 20 wt %, based on a weight amount of alkylene oxides, to obtain a reaction product, and then
c2) reacting the reaction product from c1) with at least one alkylene oxide comprising propylene oxide wherein a 1,2-propylene oxide content is more than 20 wt %, based on a weight amount of alkylene oxides, in the presence of a catalyst.

2. The process according to claim 1 wherein component B) comprises at least one reaction product of
B1) 15 to 63 wt % of one or more polyols or polyamines having an average functionality of 2.5 to 8,
B2) 2 to 30 wt % of one or more fatty acids, fatty acid monoesters, or both, and
B3) 35 to 83 wt % of one or more alkylene oxides having 2 to 4 carbon atoms,
all based on a weight amount of components B1) to B3), which adds up to 100 wt %.

3. The process according to claim 2 wherein the polyols or polyamines of component B1) are selected from the group consisting of a sugar, pentaerythritol, sorbitol, trimethylolpropane, glycerol, tolylenediamine, ethylenediamine, ethylene glycol, propylene glycol and water.

4. The process according to claim 2 wherein component B1) comprises a mixture of glycerol and sucrose.

5. The process according to claim 2 wherein component B2) comprises oleic acid or an oleic acid derivative.

6. A rigid polyurethane foam obtained by the process according to claim 2 wherein the alkylene oxide of component B3) is propylene oxide.

7. The process according to claim 1 wherein component B) has an OH number of 200 to 700 mg KOH/g.

8. The process according to claim 1 wherein component B) has a functionality of 2.5 to 8.

9. The process according to claim 1 wherein component B) is produced by a process employing an aminic alkoxylation catalyst.

10. The process according to claim 1 wherein exclusively orthotolylenediamine is employed as a starter in c1), and no further co-starters are employed in c1).

11. The process according to claim 1 wherein from 50 to 100 wt % of ethylene oxide is reacted in c1) based on the weight amount of all alkylene oxides.

12. The process according to claim 1 wherein from 70 to 100 wt % of 1,2-propylene oxide is reacted in c2) based on the weight amount of all alkylene oxides.

13. The process according to claim 1 wherein component C) is present in an amount of 1 to 50 wt % based on a total amount of components B to H.

14. The process according to claim 1 wherein polyol D) is not present.

15. The process according to claim 1 wherein component E) is present in an amount of 0 to 30 wt % based on a total amount of components B to H.

16. The process according claim 1 wherein component E) is present and is exclusively tris(2-chloropropyl)phosphate (TCPP).

17. A rigid polyurethane or polyisocyanurate foam obtained by the process according to claim 1.

18. A sandwich element having rigid or flexible outer layers, the sandwich element comprising the rigid polyurethane or polyisocyanurate foam according to claim 17.

19. A polyol mixture comprising:
B) a fatty acid modified polyetherpolyol,
C) a polyetherpolyol,
D) optionally a polyol other than those of components B) and C),
E) optionally a flame retardant,
F) optionally a blowing agent,
G) optionally a catalyst, and
H) optionally a further auxiliary, admixture agent, or both,
wherein component C) is obtained by a process comprising
c1) reacting orthotolylenediamine and optionally one or more further co-starters with at least one alkylene oxide comprising ethylene oxide wherein an ethylene oxide content is more than 20 wt %, based on a weight amount of alkylene oxides, to obtain a reaction product, and then
c2) reacting the reaction product from c1) with at least one alkylene oxide comprising propylene oxide wherein a 1,2-propylene oxide content is more than 20 wt %, based on a weight amount of alkylene oxides, in the presence of a catalyst.

20. The polyol mixture according to claim 19 comprising
20 to 90 wt % of the fatty acid modified polyetherpolyol B),
1 to 50 wt % of the polyetherpolyol C),
0 to 35 wt % of the polyol D),
0 to 30 wt % of the flame retardant E),
0.001 to 15 wt % of the catalyst G),
0.01 to 10 wt % of the further auxiliary or admixture agent H),
optionally 1 to 45 wt % of the blowing agent F),
all based on a total weight of components B) to H), wherein the wt % sum to 100 wt %.
